(19) United States
(12) Patent Application Publication
(10) Pub. No.: US 2024/0343947 A1
(43) Pub. Date: Oct. 17, 2024

(54) FILLED POLYISOBUTENE-BASED PRESSURE SENSITIVE ADHESIVES AND METHODS FOR THEIR PREPARATION AND USE

(71) Applicant: Adhesives Research, Inc., Glen Rock, PA (US)

(72) Inventors: Tsukasa Mizuhara, Seven Valleys, PA (US); Tyson Davis, Stewartstown, PA (US); Matthew Hunley, Red Lion, PA (US)

(73) Assignee: Adhesives Research, Inc., Glen Rock, PA (US)

(21) Appl. No.: 18/294,142

(22) PCT Filed: Jul. 29, 2022
(86) PCT No.: PCT/US2022/038800

§ 371 Date: Jan. 31, 2024

Related U.S. Application Data
(60) Provisional application No. 63/228,246, filed on Aug. 2, 2021.

(51) Int. Cl. C09J 7/38; C09J 9/02; C09J 11/04

(52) U.S. Cl. CPC C09J 7/381; C09J 9/02; C09J 11/04; C09J 2301/302; C09J 2301/408; C09J 2423/00

(57) ABSTRACT

Filled polyisobutene-based (PIB) pressure sensitive adhesives (PSA) comprising a polyisobutene resin and certain fillers, the fillers including silicas, aluminas, and/or acetylene (carbon) black (and optionally other fillers), as well as mixtures thereof. In certain embodiments the silica and alumina fillers are not surface-treated or otherwise modified, while in other embodiments, these fillers are surface-treated with a composition comprising an organosilane, an organosiloxane or an organosilazane, but remain unreacted in the finished PSA. The PIB PSAs may be used for a variety of applications, including as a barrier adhesive or as a component of a conductive, or non-conductive, tape.

### BACKGROUND OF THE INVENTION

The present invention generally relates to filled polyisobutene-based (PIB) pressure sensitive adhesives (PSA).

### BRIEF SUMMARY OF THE INVENTION

The present invention generally relates to compositions useful as filled polyisobutene-based (PIB) pressure sensitive adhesives (PSA) and methods for their preparation and use, the compositions comprising, consisting essentially of, or consisting of a PIB resin and a certain amount of at least one filler, wherein the filler comprises, consists essentially of, or consists of silica (desirably fumed silica), alumina (desirably fumed alumina) and/or acetylene (carbon) black, as well as optional fillers such as titanium dioxide, talc, zirconia, zinc oxide, calcium carbonate, barium sulfate, graphine, a graphine-based particulate and combinations thereof.

The inventive PSAs provide at least one, and desirably a plurality, of performance advantages relative to existing PSAs. By way of illustration and not limitation, certain embodiments of the invention provide filled PIB PSAs that exhibit improved static shear strength at higher temperatures relative to existing adhesives, relatively low creep (which may also be referred to as creep resistance), and in related embodiments also may provide the aforementioned improved static shear strength while also exhibiting at least one, and desirably a plurality of, additional beneficial properties including adhesion to polar surfaces (e.g., stainless steel and/or glass), tight liner release, water vapor transmission rate (WVTR) and, when acetylene black is used as at least one of the fillers, desirable levels of electrical conductivity.

Desirably, certain embodiments of the inventive PSAs may be used as, among other applications, a component in adhesive tapes or as barrier adhesives, the latter generally recognized as limiting water and oxygen transmission therethrough as well as providing a degree of insulation from electrical conductivity. Embodiments containing, at least, acetylene black, provide PSAs that possess conductive pathways through the adhesive, and may be used in applications requiring the aforesaid conductivity. Additional uses of the inventive PSAs are varied, and are described further herein.

### DETAILED DESCRIPTION OF THE INVENTION

The various embodiments of the invention comprise at least one PIB resin. The PIB resins are, generally, resins having a PIB resin skeleton in the main or a side chain. In some embodiments, the PIB resins are substantially homopolymers of isobutylene.

PIB resins useful in certain embodiments also may be those that are devoid of any functional groups (e.g., reactive double bonds), those that include functional groups (e.g., PIBs comprising at least about 60 mol % terminal double bonds) or mixtures of these resins. It should be appreciated, however, that non-functional PIBs may have a very small concentration of reactive double bonds or other functional groups that are residual to their manufacture, typically less than about 5, 4, 3 or 2 mol %.

When functional PIBs are included in embodiments of the invention, it should be understood that such embodiments should not include any component that would react with the functional PIBs, e.g., undergo a crosslinking reaction, nor be subjected to any conditions that would initiate such a reaction.

Illustrative of suitable commercially-available PIB resins that are non-functional include those in the OPPANOL® B and N Series (BASF), e.g., OPPANOL B10 (about 40,000 g/mol, viscosity average molecular weight (vMW)), B11 (about 47,000 vMW) B12 (about 55,000 vMW), B13 (about 65,000 vMW), B14 (about 73,000 vMW), B15 (about 85,000 vMW), N50 (about 425,000 vMW) N80 (about 800,000 vMW), N100 (about 1,100,000 vMW) and N150 (about 2,600,000 vMW), each of which may contain from about 1 to about 500 ppm of a stabilizer such as BHT. Illustrative of suitable commercially-available functional PIBs include those in the GLISSOPAL® Series (BASF), e.g., 1000, 1300, and 2300 and in the V-Series, e.g., V190, V230, V430, V500, V640, V700, V800, V950 and V1500.

In some embodiments, the PIB resins may comprise copolymers of isobutylene such as, for example, synthetic rubbers wherein isobutylene is copolymerized with another monomer. Synthetic rubbers include butyl rubbers which are copolymers of mostly isobutylene with a small amount of isoprene such as, for example, butyl rubbers. Illustrative of such suitable commercially-available synthetic rubbers include those available under tradenames VISTANEX® (Exxon Chemical Co.) and JSR BUTYL® (Japan Butyl Co., Ltd.).

The aforesaid synthetic rubbers also may include copolymers of mostly isobutylene with styrene, n-butene or butadiene. In some embodiments, a mixture of isobutylene homopolymer and butyl rubber may be used. Other useful copolymers include styrene-isobutylene diblock copolymer (SIB) and styrene-isobutylene-styrene triblock copolymer (SIBS), available under the tradename SIBSTAR® (Kaneka Corporation).

The PIB resins desirably may have a vMW ranging from about 40,000 to about 3,000,000 g/mol.

Desirably, and in some embodiments, two PIB resins having differing vMWs may be used. In these embodiments, the resins will comprise at least one relatively low vMW resin, and at least one relatively high vMW resin. Low vMW resins useful in the embodiments of the invention may have a vMW ranging from about 35,000 to about 100,000 g/mol, desirably from about 40,000 to about 75,000 g/mol, more desirably from about 45,000 to about 65,000 g/mol, and even more desirably from about 50,000 to about 60,000 g/mol. High vMW resins useful in the embodiments of the invention may have a vMW average ranging from about 300,000 to about 3,000,000 g/mol, desirably from about 400,000 to about 2,500,000 g/mol, more desirably from about 500,000 to about 2,000,000 g/mol, even more desirably from about 700,000 to about 1,500,000 g/mol. Preferably, the high vMW resins may have a vMW ranging from about 800,000 to about 1,300,000 g/mol, more preferably from about 900,000 to about 1,200,000 g/mol, and even more preferably from about 900,000 to about 1,100,000 g/mol.

The inventive filled PIB PSAs further comprise, consist essentially of, or consist of at least one filler, wherein the filler comprises, consists essentially of, or consists of silica (desirably fumed silica), alumina (desirably fumed alumina), and/or acetylene black, with optional fillers comprising titanium dioxide, talc, zirconia, zinc oxide, calcium carbonate, barium sulfate, graphine, graphine-based particulates, precipitated silica (wax-treated), precipitated calcium carbonate and combinations thereof. The fillers should be in the form of particulates, and may have a BET specific surface area ranging from about 1 to about 400 m²/g.

Certain embodiments of the invention include silicas as one filler, and desirably as the sole filler, in the PSA. These silicas are preferably fumed silicas and are well-known to those skilled in the art. Further, and desirably in certain embodiments, these fumed silicas are not surface-treated (NST) and are therefore generally considered in the relevant art to be hydrophilic. In some embodiments, the NST silicas may have a BET specific surface area ranging from about 50 to about 400 m²/gram, and more desirably in those embodiments from about 150 to about 300 m²/gram, and/or are non-granulated. Illustrative of commercially-available NST silicas include, but are not limited to, AEROSIL® fumed silicas (Evonik, Germany), e.g., AEROSIL® 150, 200, 300 and 380 and CAB-O-SIL® and CAB-O-SPERSE® fumed silicas (Cabot Corp, Boston, MA).

Aluminas, and desirably fumed aluminas, also are useful as fillers in certain embodiments of the invention, and desirably as the sole filler. These aluminas are well-known to those skilled in the art. Desirably, in certain embodiments, the fumed aluminas are not surface-treated and, consistent with the description of NST silicas, are therefore generally considered in the relevant art to be hydrophilic. In some embodiments, the NST aluminas may have a BET specific surface area ranging from about 50 to about 400 m²/gram, and more desirably in those embodiments from about 80 to about 150 m²/gram. Illustrative of commercially-available NST aluminas include, but are not limited to, AEROXIDE® Alu C (Evonik, Germany) and SpectrAI® fumed aluminas (Cabot Corp., Boston, MA).

Other embodiments of the invention contemplate the use of surface-treated (ST) silicas and ST aluminas as fillers, desirably ST fumed silicas and aluminas, and more desirably with each being the sole filler. These ST silicas and ST aluminas are well-known, and, because they are surface-treated with a hydrophobic component, are generally considered in the relevant art to be hydrophobic. The surface of these ST silicas and aluminas comprise, consist essentially of, or consist of an organosilane (which includes organohalosilanes and aminosilanes), an organosiloxane, an organosilazane or mixtures thereof.

Preferably, the organosilane may be one or more of methacryloyloxypropy-Itrialkoxysilane, aminopropylsilane, octyltrialkoxysilane (e.g., octyltrimethoxysilane, OCTMO), hexadecyltrialkoxysilane, dimethyldialkoxysilane, dimethyldichlorosilane and trimethylalkoxysilane, while an organosiloxane may be polydimethylsiloxane, and the organosilazane may be hexamethyldisilazane.

The ST fumed silicas have a BET specific surface area that may vary, and in some embodiments may range from about 80 to about 400 m²/gram, more desirably in those embodiments from about 100 to about 350 m²/gram, and even more desirably from about 125 to about 300 m²/gram. The ST fumed aluminas also may have a BET specific surface area that varies, and in some embodiments may range from about 50 to about 150 m²/gram, and more desirably in those embodiments from about 75 to about 110 m²/gram.

Illustrative of commercially-available ST silicas include, but are not limited to, AEROSIL® and CAB-O-SIL® ST fumed silicas, e.g., AEROSIL® R711, AEROSIL® R805, AEROSIL® R974 and AEROSIL® RA200HS (Evonik, Germany), while illustrative commercially-available ST aluminas include, but are not limited to, AEROXIDE® ST fumed aluminas, e.g., AEROXIDE® Alu C 805 (Evonik, Germany). Generally, the “R” series AEROSIL® and CAB-O-SIL® ST fumed silicas do not include methacryloyl or amino groups, with the exception of R711 which includes a methacryloyl group and RA200HS which includes an amino group.

Acetylene black (e.g., carbon black) also may be useful as a filler in various embodiments of the invention, particularly when a conductive PSA is desired. In certain embodiments, acetylene black may be the sole filler, while in other more desirable embodiments the acetylene black may be present in combination with alumina and/or silica fillers as described herein. Acetylene black is well-known to those skilled in the art, and is not surface-treated. While the acetylene black may have a BET specific surface area that varies, in certain embodiments the acetylene black may have a BET specific surface area ranging from about 60 to about 150 m²/gram.

Illustrative of commercially-available acetylene blacks include, but are not limited to, AB 50%-01, AB 75%-01, AB 100%-01 and ABHC-01 (Soltex, Houston, TX), DENKA BLACK (Denka Co., Ltd., Tokyo, Japan), and Y50A (Orion Engineered Carbons, Houston, Texas).

Other optional fillers that may be included in embodiments of the present invention include one or more of, but desirably only one of, titanium dioxide (and more desirably a fumed NST hydrophilic TiO₂ having a BET specific surface area ranging from about 30 to about 70 m²/g), talc, zirconia, zinc oxide, calcium carbonate, barium sulfate, graphine, and a graphine-based particulate.

Various embodiments of the invention, which contemplate PIB PSAs which include the aforementioned and other ingredients, as well as products which incorporate those PSAs, are described in more detail below.

Certain embodiments of the present invention contemplate a composition for providing a filled PIB PSA, as well as a filled PIB PSA, comprising, consisting essentially of, or consisting of: (a) about 10 to about 30 wt. % of a PIB resin having a vMW ranging from 300,000 to about 3,000,000 g/mol; (b) about 30 to about 60 wt. % of a PIB resin having a vMW ranging from about 35,000 to about 100,000 g/mol; and (c) about 8 wt. %, and more desirably about 15 wt. %, to about 25 wt. % of a NST fumed silica; wherein the weight ratio of resin (a) to resin (b) ranges from about 1:1 to about 1:5, desirably from about 1:2 to about 1:3, and wherein the weight percents are based on the non-volatile components (e.g., solvents such as toluene) in the composition or filled PIB PSA.

These embodiments, having a weight ratio of the relatively high vMW resin to relatively low vMW resin (also referred to herein as the resin weight ratio) of about 1:2 to about 1:3, and preferably about 1:2, was unexpectedly found to provide a PSA that exhibits a static shear strength (70° C., 500 grams) which is at least 5 times (e.g., at least 10 minutes, wherein references herein to “minutes” refers to the time observed while performing the static shear strength testing protocol described herein) greater than that exhibited by a comparator non-filled PIB PSA (i.e., a PIB PSA which does not include any filler,) when the NST fumed silica loading was at about 8 wt. %. Further increases in the amount of NST fumed silica also were unexpectedly found to provide non-linear increases in static shear strength, with the static shear strength increasing to at least 100 minutes at a fumed silica loading of about 15 wt. % to about 25 wt. %, with a further increase to at least about 10,000 minutes (with 10,000 minutes being selected as the practical time limit for static shear strength testing) at a NST fumed silica loading of about 20 wt. to about 25 wt. %, with the loading preferably ranging from about 21 wt. % to about 23 wt. %. It was further, and unexpectedly, discovered that increasing the NST fumed silica loading above 23 wt. % is undesirable due to an undesirable increase in WVTR and tight liner release properties.

In addition, the aforementioned PSA also desirably exhibits acceptable peel strength. Peel strength may be described as the force needed to break the bond between an adhesive and the surface onto which it has been applied, with a higher peel strength being more desirable (but, generally, not to exceed about 120 oz/inch). In the context of this embodiment of the invention, peel strength ranges from at least about 10 or 20 oz/inch, to at least about 40 or 50 oz/inch, and up to about 60, 65, 75, 85 or 100 oz/inch, at a NST fumed silica loading of from about 8 wt. % to about 25 wt. %. That the peel strength remained at least about 40, 45 or 50 oz/inch at the aforesaid NST fumed silica loading levels while the static shear strength increased substantially (and non-linearly), also was an unexpected, and desirable, attribute of this embodiment of the inventive PSAs.

A further unexpected aspect of this PSA is that, at a NST fumed silica loading of about 20 wt. % or less, the tight liner release, with a silicone liner, was from about 1, 5, 10, 15, 20, 25, 30 or 35 grams/2 inches to no more than about 100, 80, 60, 50 or 40 grams/2 inches.

It is also desirable that the aforedescribed PSA provides at least two or, more desirably, all three of the foregoing properties, e.g., static shear strength ranging from at least about 10, 50, 100, 200, 300, 400 or 500 minutes up to about 1,000, 2,500, 5,000 or 10,000 minutes; peel strength ranging from at least about 10, 20 or 25 oz/inch up to at least about 40, 50, 60, 65, 75, 85, or 100 oz/inch; and tight liner release from about 1, 5, 10, 15, 20, 25, 30 or 35 grams/2 inches to no more than about 100, 80, 60, 50 or 40 grams/2 inches.

Further embodiments of the invention contemplate a composition for providing a filled PIB PSA, as well as a filled PIB PSA, comprising, consisting essentially of, or consisting of: (a) about 10 to about 30 wt. % of a PIB resin having a vMW ranging from 300,000 to about 3,000,000 g/mol; (b) about 30 to about 60 wt. % of a PIB resin having a vMW ranging from about 35,000 to about 100,000 g/mol; and (c) about 20 to about 30 wt. % of a NST fumed alumina; wherein the weight ratio of resin (a) to resin (b) ranges from about 1:1 to about 1:5, desirably from about 1:2 to about 1:3, and more desirably about 1:2, and wherein the weight percents are based on the non-volatile components (e.g., solvents such as toluene) in the composition or filled PIB PSA.

In these embodiments, it was found that a resin weight ratio of the relatively high vMW resin to relatively low vMW resin of about 1:2 to about 1:3, and preferably about 1:2.5 to about 1:3, provided a PSA that unexpectedly exhibited a desirable static shear strength (70° C., 500 grams) which is at least about 5 times (e.g., at least 10 minutes) greater than that exhibited by a comparator non-filled PIB PSA (i.e., a PIB PSA which does not include any filler, in this case fumed silica or fumed alumina), although the NST fumed alumina loading required to obtain this increase was significantly higher (at least about 20 wt. %) compared to the amount required when NST fumed silica was used as the filler in the same resin carrier composition. Static shear strengths (70° C., 500 grams) of at least about 30, 50, 80, 100 or 140 minutes, and desirably up to about 200, 250, 300, 400 or 500 minutes, may be provided by this embodiment.

It was further found that a certain ratio of relatively high vMW resin to relatively low vMW resin had an unexpected, and desirable, effect on the static shear strength of the PSA at the same NST fumed alumina loading levels. Specifically, it was found that a resin (a) to resin (b) weight ratio of from about 1:2.5 to about 1:3 provided a significant increase (e.g., at least about double at about a 1:2.5 ratio and at least about 4 times at about a 1:3 ratio) in static shear strength (70° C., 500 grams) relative to that exhibited by a PSA using a resin (a) to resin (b) weight ratio of about 1:2 (and including the same amount of the NST fumed alumina).

In addition, and also unexpectedly, it was found that relatively small increases in the amount of NST fumed alumina provided non-linear increases in static shear strength. For example, at a resin (a) to resin (b) weight ratio of about 1:2.5, an increase in NST fumed alumina content from about 22 wt. % to about 25 wt. % provided an increase in static shear strength (70° C., 500 grams) of at least about 2-3 times. Similarly, at a resin (a) to resin (b) weight ratio of about 1:3, an increase in NST fumed alumina content from about 22 wt. % to about 30 wt. % provided an increase in static shear strength of at least about double.

In addition, it was further found that this embodiment of the inventive PSAs also desirably exhibits acceptable peel strength (on a stainless steel substrate) of at least about 20, 25, 30, 40, 45, or 50 oz/inch and up to about 55, 60, 65, 70, 75, 85, 95 or 100 oz/inch, at NST fumed alumina loading of up to about 30 wt. %. That the peel strength was at least about 40, and desirably at least about 45, oz/inch, at the aforesaid NST fumed alumina loading levels while the static shear strength increased substantially also was an unexpected, and desirable, attribute of this embodiment of the invention which includes NST fumed alumina-containing PSAs.

It is also desirable that the aforedescribed NST fumed alumina-containing PSAs provide at least two or, more desirably, all three of the foregoing properties, e.g., static shear strength ranging from at least about 10, 20, 30, 50, 80, 100 or 120 minutes and up to about 150, 200, 250, 300, 400, 500, 1,000 or 2,000 minutes; peel strength ranging from at least about 20, 25, 30, 40, 45, 50, 55 or 60 oz/inch and up to about 65, 70, 75, 85, 95 or 100 oz/inch; and tight liner release from about 10, 20 or 30 grams/2 inches to no more than about 100, 80, 60, 50 or 40 grams/2 inches.

Other embodiments of the invention contemplate a composition for providing a filled PIB PSA, as well as a filled PIB PSA, comprising, consisting essentially of, or consisting of: (a) about 10 to about 40 wt. % of a PIB resin having a vMW ranging from 300,000 to about 3,000,000 g/mol; (b) about 40 to about 80 wt. % of a PIB resin having a vMW ranging from about 35,000 to about 100,000 g/mol; (c) about 8 to about 30 wt. % of a ST fumed silica; wherein the weight ratio of resin (a) to resin (b) ranges from about 1:2 to about 1:7, more preferably from about 1:2 to about 1:3, and even more preferably about 1:2.5 to about 1:3, or about 1:3, and wherein the weight percents are based on the non-volatile components (e.g., solvents such as toluene) in the composition or filled PIB PSA.

As discussed in more detail herein, the use in PIB PSAs of ST fumed silicas, which remain unreacted in the PSAs, surprisingly provide advantages relative to PIB PSAs which do not include any ST fumed silica or fumed alumina therein, as well as relative to PIB PSAs that include NST fumed silicas.

This embodiment of the inventive filled PIB PSAs provides at least about a 2-fold increase in static shear strength (70° C., 500 grams) in the PSA with the inclusion of about 8 wt. % of the ST fumed silica relative to a PSA having no filler using the same resin (a) to resin (b) of weight ratio (about 1:2). Further increases are observed with increased ST fumed silica loading, however, it was unexpectedly found that ST fumed silica loading at between about 15 wt. % and about 30 wt. % provided a non-linear increase in static shear strength (70° C., 500 grams) of at least about 10 times that of a PSA having no filler, e.g., at least about 10, 20, 50, 100, 200, 1,000, 2,000, 5,000, or 10,000 minutes (with 10,000 minutes being selected as the practical time limit for static shear strength testing) in PIB PSAs having a resin weight ratio of between about 1:2 and about 1:7.

ST fumed silica comprising an octyltrialkoxysilane (e.g., octyltrimethoxysilane, OCTMO) also was unexpectedly found to provide relatively higher static shear strength relative to a fumed silica treated with a composition comprising an alkylsilane (e.g., methylsilane) at loading levels ranging from about 20 to about 30 wt. %.

Enhanced static shear strength also was unexpectedly found using ST fumed silica at loading levels of between about 20 wt. % and about 30 wt. %, with about 22 wt. % to about 25 wt. % being preferred.

The use of certain resin weight ratios in these embodiments also was found to effect the static shear strength, with resin (a) to resin (b) weight ratios of about 1:2.5 to about 1:3, and desirably about 1:3, providing higher strengths relative to compositions using lower resin (a) to resin (b) weight ratios (e.g., 1:2) or higher (up to 1:7) with the same ST fumed silica loading levels.

In addition, these PSAs also desirably exhibit acceptable peel strength (on a stainless steel substrate) of at least about 20, 25, 30, 40, 45, 50 or 55 oz/inch, and up to about 60, 65, 70, 75, 85 or 100 oz/inch, at a surface-treated fumed silica loading of from about 8 wt. % to about 25 wt. %. That the peel strength remained substantially constant at the aforesaid surface-treated fumed silica loading levels while the static shear strength increased substantially (and non-linearly) also was an unexpected, and desirable, attribute of these inventive PSAs.

A further unexpected aspect of this PSA is that, at a ST fumed silica loading of about 8 wt. % to about 25 wt. %, the tight liner release on silicone liners was acceptable, e.g., desirably from about 1, 5 or 10 grams/2 inches to no more than about 40, 30, 25 or 20 grams/2 inches. In addition, and also surprisingly, PSAs having a resin (a) to resin (b) of ratio of about 1:2 to about 1:3, and a ST fumed silica loading of from about 22 wt. % to about 25 wt. %, exhibited WVTR values of from about 3 to about 11 g-mil/m²/day, with PSAs having a resin (a) to resin (b) weight ratio of about 1:2 providing a static shear strength (70° C., 500 grams) of at least about 100 minutes, acceptable tight liner release of up to about 40 gram/2 inches (silicone liners) and a WVTR of no more than about 3 g-mil/m²/day.

It is also desirable that the aforedescribed embodiments comprising ST fumed silica provides at least two, three or, more desirably, all four of the foregoing properties, e.g., static shear strength ranging from at least about 10, 20, 30, 50, 80 or 100 minutes and up to about 200, 250, 500, 1,000, 2,500, 5,000 or 10,000 minutes; peel strength ranging from at least about 20, 25, 30, 40, 45, 50 or 55 oz/inch, and up to about 60, 65, 70, 75, 85 or 100 oz/inch; tight liner release from about 1, 5 or 10 grams/2 inches to no more than about 40, 30, 25 or 20 grams/2 inches; and WVTR of from about 1 or 2 up to about 3, 5, 7, 9 or 11 g-mil/m²/day.

Further embodiments of the invention provide a composition for providing a filled PIB PSA, and a filled PIB PSA, comprising, consisting essentially of, or consisting of: (a) about 20 to about 30 wt. % of a PIB resin having a vMW ranging from 300,000 to about 3,000,000 g/mol; (b) about 40 to about 60 wt. % of a PIB resin having a vMW ranging from about 35,000 to about 100,000 g/mol; (c) about 20 to about 35 wt. %, desirably from about 20 wt. % to about 30 wt. %, and more desirably from about 25 wt. % to about 30 wt. %, of a ST fumed alumina; wherein the weight ratio of resin (a) to resin (b) ranges from about 1:2 to about 1:3, more desirably from about 1:2.5 to about 1:3, and wherein the weight percents are based on the non-volatile components (e.g., solvents such as toluene) in the composition or filled PIB PSA.

As discussed in more detail herein, the use in these embodiments of fumed aluminas which have been surface-treated (as described herein), yet which remain unreacted in the finished PSA, unexpectedly provide advantages relative to PIB PSAs which do not include any fumed silica or fumed alumina, and, further unexpectedly, also relative to PIB PSAs that include NST fumed silicas or fumed aluminas.

For example, these embodiments of the inventive filled PIB PSAs comprising ST fumed alumina provide an increase in static shear strength (70° C., 500 grams) with the inclusion of about 20 wt. % of ST fumed alumina relative to filler-PSAs using a resin weight ratio of resin (a) to resin (b) of about 1:2, and desirably at least about a 4-fold increase when using a resin weight ratio of resin (a) to resin (b) of about 1:3. Further increases are observed with increased ST fumed alumina loading, however, it was unexpectedly found that ST fumed alumina loading at between about 20 wt. % and about 35 wt. % provided desirable static shear strengths (70° C., 500 grams), e.g., at least about 10, 20, 50, 75, 100, 125 or 150 minutes, and up to about 175, 200, 250, 300, 400 or 500 minutes, in PIB PSAs having a resin (a) to resin (b) weight ratio of about 1:3.

Enhanced static shear strength in PSAs was unexpectedly found using ST fumed silica at loading levels of between about 25 wt. % and about 35 wt. %, with about 28 wt. % to about 32 wt. % being preferred. Loading at relatively higher levels, e.g., above 40 wt. %, and at a resin (a) to resin (b) weight ratio of about 1:3, was surprisingly found to provide a PSA with negligible static shear strength.

In addition, the PSAs also desirably exhibit acceptable peel strength (on a stainless steel substrate) of at least about 20, 30, 40, 45, 50, or 55 oz/inch, and up to about 60, 65, 70, 75, 80, 85, 90 or 100 oz/inch, at a surface-treated fumed alumina loading of from about 20 wt. % to about 35 wt. %. That the peel strength remained at least about 40, 50 or 60 oz/inch at the aforesaid ST fumed alumina loading levels while the static shear strength increased substantially also was an unexpected, and desirable, attribute of these inventive PSAs.

Certain embodiments of the invention were found to provide several acceptable properties in the PSAs. One of these embodiments constitutes PSAs that comprise, consist essentially of, or consist of (a) about 15 to about 25 wt. % of a PIB resin having a vMW ranging from 300,000 to about 3,000,000 g/mol; (b) about 20 to about 40 wt. % of a PIB resin having a vMW ranging from about 35,000 to about 100,000 g/mol; (c) about 20 to about 25 wt. % of a ST fumed silica (wherein the surface treatment desirably comprises an octyltrialkoxysilane), and (d) about 20 to about 40 wt. % of a tackifier, wherein the PSA exhibits one, two, three of all four of: a static shear strength of about 40 to about 150 minutes, a peel strength of about 40 to about 70 oz/inch, a tight liner release of about 20 to about 40 grams/2 inch, and a WVTR of about 2 to about 20 g-mil/m²/day, and wherein the weight percents are based on the non-volatile components in the PSAs. A further such embodiment constitutes PSAs that comprise, consist essentially of or, or consist of (a) about 10 to about 25 wt. % of a PIB resin having a vMW ranging from 300,000 to about 3,000,000 g/mol; (b) about 30 to about 40 wt. % of a PIB resin having a vMW ranging from about 35,000 to about 100,000 g/mol; (c) about 15 to about 20 wt. % of a ST fumed silica (wherein the surface treatment desirably comprises an dimethyldichlorosilane) and (d) about 15 to about 25 wt. % of a tackifier, wherein the PSA exhibits one, two, three or all four of: a static shear strength of about 50 to about 150 minutes, a peel strength of about 40 to about 70 oz/inch, a tight liner release of about 20 to about 40 grams/2 inch, and a WVTR of about 2 to about 20 g-mil/m²/day, and wherein the weight percents are based on the non-volatile components in the PSAs.

A further unexpected aspect of these embodiments is that, at ST fumed alumina loading of about 20 wt. % to about 35 wt. %, and more desirably from about 27 to about 33 wt. %, the tight liner release of PSAs on silicone liners was acceptable, e.g., from about 1, 5, 10 or 15 grams/2 inches to no more than about 100, 75, 50, 25 or 20 grams/2 inches.

It is also desirable that the aforedescribed embodiments comprising ST fumed silicas provide at least two, three or, more desirably, all four of the foregoing properties, e.g., static shear strength ranging from at least about 10, 20, 50, 75, 100, 125 or 150 minutes up to about 175, 200, 250, 300, 400 or 500 minutes; peel strength ranging from at least about 20, 30, 40, 45, 50 or 55 oz/inch up to about 60, 65, 70, 75, 80, 85, 90 or 100 oz/inch; and tight liner release from about 1, 5, 10 or 15 grams/2 inches to no more than about 100, 75, 50, 25 or 20 grams/2 inches; and a WVTR of about 2 to about 20 g-mil/m²/day.

As mentioned, in the embodiments of the invention, it is further contemplated that the ST silicas and aluminas, which contain functional groups that, under certain conditions, may chemically react with another ingredient that includes a functional group, remain unreacted (e.g., non-crosslinked). In this regard, PSAs comprising ST silicas and aluminas should not also include any crosslinking agents and/or catalysts (e.g., chemicals), nor intentionally be subjected to any conditions (e.g., radiation or heat) that would cause the functional groups in the ST silicas or aluminas to undergo a chemical reaction. This being said, it should be understood that to the extent some minimal crosslinking or other reactions may be found to occur in the inventive embodiments even in the absence of catalysts or the application of radiation or heat, such constitute embodiments of the invention.

Further embodiments of the invention contemplate conductive filled PIB PSAs comprising, consisting essentially of, or consisting of: (a) about 10 to about 30 wt. % of a PIB resin having a vMW ranging from 300,000 to about 3,000,000 g/mol; (b) about 30 to about 60 wt. % of a PIB resin having a vMW ranging from about 35,000 to about 100,000 g/mol; and (c) about 1 to about 25 wt. % of acetylene black (desirably about 5 to about 22 wt. %, and more desirably from about 8 to about 15 or 20 wt. %), wherein the weight ratio of resin (a) to resin (b) ranges from about 1:2 to about 1:3, and wherein the weight percents are based on the non-volatile components (e.g., solvents such as toluene) in the PSA.

It was found that the inclusion of acetylene black in amounts of at least about 8 wt. % provided an unexpected increase in the static shear strength of the conductive PSA, with said unexpected increase being more pronounced at a loading of at least about 15 wt. %. It was also found that this static shear strength increase continued to be observed at acetylene black loading levels of up to about 22 wt. %, but that this strength was accompanied by an undesirable loss of peel strength, rendering the desirable acetylene black loading to no more than about 22 wt. %, and preferably no more than about 20 wt. %. The addition of a tackifier to this 22 wt. % acetylene black composition, even in an amount of 30 wt. %, did not affect the peel strength.

These conductive PSAs desirably exhibit one or more of: a static shear strength (70° C., 500 grams) ranging from at least about 10, 20, 30, 40 or 50 to about 60, 80, 90, 100, 150, 200 or 250 minutes; a peel strength (on a stainless steel substrate) ranging from at least about 10, 20, 30 or 40 to about 50, 55, 60, 65, 75, 85 or 100 oz/inch; a tight liner release (using AR-W4 as the liner) ranging from at least about 10, 15, 20, 25, 30 or 35 up to about 40, 50, 60, 70, 80, 90 or 100 grams/2 inch; and a WVTR of from about 2 to no more than about 20, 15, 10 or 7 g-mil/m²/day. These PSAs further exhibit a fifth property, resistivity (which is the inverse of conductivity, and as such may be used to describe conductivity), that desirably may range about 0.1 or 1 to about 2, 5, 7, 10, 15, 20 or 25 mOhms (5 microns at 11 lbs) or from about 1, 5 or 10 to about 15, 20, 25, 50, 100, 200, 300, 400 or 500 mOhms (1 mil at 11 lbs). Alternatively, the conductive PSAs may have an electrical resistivity measured in ohm-cm via four point resistivity method (described herein) ranging from about 0.01 to about 0.5 ohm-cm.

Certain embodiments of the invention were found to provide several acceptable properties in the PSAs. These embodiments constitute PSAs that comprise, consist essentially of, or consist of (a) about 10 to about 15 wt. % of a PIB resin having a vMW ranging from 300,000 to about 3,000,000 g/mol; (b) about 45 to about 55 wt. % of a PIB resin having a vMW ranging from about 35,000 to about 100,000 g/mol; (c) about 3 to about 5 wt. % of acetylene black, and (d) about 27 to about 32 wt. % of a tackifier, wherein the PSA exhibits one, two, three or all four of: a static shear strength of about 10 to about 50 minutes, a peel strength of about 40 to about 70 oz/inch, a tight liner release of about 20 to about 40 grams/2 inch, and a WVTR of about 2 to about 20 g-mil/m²/day, and wherein the weight percents are based on the non-volatile components in the PSAs.

In a related embodiment, alumina may be added to the aforedescribed acetylene black-containing PSAs in amounts ranging from about 5 to about 30 wt. %, more desirably about 5 to about 20 wt. %, and even more desirably from about 7, or more desirably about 10, to about 15 wt. %, and wherein the alumina is preferably fumed alumina, and more preferably NST fumed alumina. Desirably, in these embodiments, the acetylene black may be included in amounts ranging from about 5, 7 or preferably about 10 to about 15 wt. %, and more desirably in combination with from about 10 to about 15 wt. % alumina.

It was surprisingly found that the inclusion of alumina in acetylene black-containing PIB PSAs provided PSAs that exhibited enhanced conductivity, despite alumina being a non-conductive material. It was further found that NST alumina provided increased static shear strength, and better peel strength properties, relative to ST alumina when included in a composition or PSA in the same weight percentage. Further information and data on these unexpected properties may be found in the examples section.

It is further desirable that the aforedescribed embodiments (alumina with acetylene black) provides PSAs having at least one, two or, more desirably, all three of the following properties, e.g., static shear strength ranging from at least about 10, 20 or 30 minutes up to about 50, 75, 100, 125, 150 or 200 minutes; peel strength ranging from at least about 15, 20 or 25 oz/inch up to about 40, 45 or 50 oz/inch; and tight liner release of from about 10, 15 or 20 grams/2 inches to no more than about 100, 75, 50, 40 or 30 grams/2 inches.

In yet another related embodiment, silica may be added to the aforedescribed acetylene black-containing PSAs in amounts ranging from about 5 to about 30 wt. %, desirably from about 5 to about 20 wt. %, and even more desirably from about 7, or more preferably from about 10, to about 15 wt. %, and wherein the silica is preferably fumed silica, and more preferably ST fumed silica. Desirably, in these embodiments, the acetylene black may be included in amounts ranging from about 5, 7 or, preferably, 10 to about 15 wt. %, and more desirably in combination with from about 10 to about 15 wt. % silica.

It was surprisingly found that the inclusion of silica in acetylene black-containing embodiments of the invention provided PSAs that exhibited conductivity, peel strength, tight liner release and WVTR values that were similar to that exhibited when silica was omitted, while also providing a desirable increase in static shear strength. Further information and data on these unexpected properties may be found in the examples section. It is further desirable that the aforedescribed embodiments (silica with acetylene black) provide at least one, two, three or, more desirably, all four of the following properties: static shear strength ranging from at least about 10, 20 or 30 minutes up to about 100, 250, 500, 1,000, 2,500, 5,000 or 10,000 minutes; peel strength ranging from at least about 15, 20 or 25 oz/inch up to about 40, 45 or 50 oz/inch; tight liner release of from about 10, 15 or 20 grams/2 inches to no more than about 100, 75, 50, 40 or 30 grams/2 inches; and WVTR ranging from about 3 to about 10 g-mil/m²/day.

In another related embodiments, silica and alumina may be added to the aforedescribed acetylene black-containing PSAs in combined amounts ranging from about 5 to about 20 wt. %, and more desirably about 5 to about 15 wt. %, and even more desirably from about 7, or more preferably from about 10, to about 15 wt. %, and wherein the silica and alumina are each preferably fumed, and more preferably are ST fumed silica and NST alumina. Desirably, in these embodiments, the acetylene black may be included in amounts ranging from about 5, 7 or, preferably, 10 to about 15 wt. %. While this embodiment provided a PSA with good static shear strength, tight liner release and WVTR, it did suffer from less than optimal peel strength. Further information and data on these unexpected properties may be found in the examples section.

It is further desirable that the aforedescribed embodiment of the inventive PSAs (which contains silica, alumina and acetylene black) provides at least one, two, three or, more desirably, all four of the following properties: static shear strength ranging from at least about 10, 20, 50 minutes up to about 100, 125, 150 or 200 minutes; peel strength ranging from at least about 10, 15, 20 or 25 up to about 30, 35, 40 or 50 oz/inch; tight liner release of from about 10, 15 or 20 grams/2 inches to no more than about 100, 75, 50, 40 or 30 grams/2 inches; and WVTR ranging from about 3 to about 10 g-mil/m²/day. These PSAs may further exhibit resistivity ranging about 0.1 or 1 to about 2, 5, 7, 10, 15, 20 or 25 mOhms (5 microns at 11 lbs) or from about 1, 5 or 10 to about 15, 20, 25, 50, 100, 200, 300, 400 or 500 mOhm (1 mil at 11 lbs). Alternatively, the conductive PSAs may have an electrical resistivity measured in ohm-cm via four point resistivity method (described herein) ranging from about 0.01 to about 0.5 ohm-cm.

In a related embodiment, it was found that an acetylene black-containing PSA that contains substantially only relatively high vMW PIB resins (e.g., relatively low vMW PIB resins at from 0 wt. % (no detectable amount) up to no more than about 1 wt. %) can provide desirable static shear and, in some preferred embodiments, desirable peel strength. This embodiment provides a conductive pressure-sensitive adhesive comprising, consisting essentially of, or consisting of: (a) about 10 to about 30 wt. % of a PIB resin having a vMW ranging from 300,000 to about 3,000,000 g/mol; (b) acetylene black, desirably in an amounts ranging from about 0.1 to about 5 wt. %; and (c) about 8 to about 20 wt. % of a filler comprising, consisting essentially of or consisting of ST fumed silica; wherein the weight percents are based on non-volatile ingredients in the pressure sensitive adhesive. This embodiment desirably further comprises a tackifier, more desirably in an amount ranging from about 10 to about 60 wt. %, and even more desirably from about 30 to about 60 wt. %. In this embodiment, static shear strength may reach about 25 mins, 100 mins, 500 mins, 1,000 mins, 2,500 mins and 5,000 mins (at 250 grams).

Uses of aforesaid acetylene black-containing PSAs may vary, with one illustrative use being a component of a conductive tape. This embodiment comprises, consists essentially of, or consists of: (a) a substrate comprising an upper and lower surface; (b) the conductive filled PIB PSA as described hereinabove; and (c) a release liner which contacts at least a portion of the filled PIB adhesive.

The PSAs described herein may, but desirably do not, include clays as fillers, and as such the amount of any clay therein is desirably limited. For example, in embodiments of the invention, it is desirable that the clay fillers, if present, comprise no more than about 1 wt. % of, more desirably no more than about 0.5 wt. % of, even more desirably no more than about 0.1 wt. % of, and most desirably are not detectable.

Tackifiers comprise an optional, yet desirable, ingredient in certain embodiments of the invention. Generally speaking, tackifiers are substances that enhance the tack of a PIB PSA relative to a PIB PSA without the tackifier. Tack may be described as a measure of how quickly an adhesive bond is formed when two surfaces are brought together with light pressure; the faster two surfaces bond, the higher the tack. The inclusion of a tackifier also may permit the preparation of a PIB PSA exhibiting an acceptable adhesion onto a polar surface using a relatively lower amount of PIB resin. Tackifiers, when included in the inventive PSAs described herein, were advantageously found to have a limited effect on the static shear strength of the PSAs.

When included, a tackifier may be included in any amount, but is desirably included in amounts ranging from about 1 to about 60 wt. %, more desirably from about 1 to about 30 wt. %, even more desirably from about 5 to about 20 wt. %, and preferably from about 10 to about 15 wt. %, based on the non-volatile components in the composition or filled PIB PSA. While the tackifiers may include reactive functional groups, they should not undergo any reaction in the composition or PSA, e.g., a crosslinking reaction. Illustrative of tackifiers that may be useful in the various embodiments of the invention include terpenes, e.g., terpene phenolic esters, aliphatic- or aromatic-modified C₅ to C₉ hydrocarbons, rosin esters, coumarine-indene resins PIBs having relatively low vMW (from about 500 vMW to about 5,000 vMW) and mixtures thereof. Illustrative of suitable commercially available tackifiers include, but are not limited to, Arkon P and M Series hydrogenated hydrocarbon resins (Arakawa Chemical, Japan) and Indopol H Series polybutenes (Palmer Holland, USA).

When a tackifier is included in embodiments which include a ST fumed silica, e.g., at from about 10 to about 30 wt. % tackifier, it was unexpectedly found that the static shear strength of the PSA does not diminish, but is instead enhanced, in some cases by an order of magnitude or more, relative to a non-filled tackifier-free PIB PSA. This desirable property was observed even when the ST fumed silica is included at relatively high concentrations, e.g., from about 20 to about 35 wt. %, and desirably from about 25 to about 30 wt. %. While any of the ST fumed silicas described herein may be used, it is desirable to use a ST fumed silica comprising an octyltrialkoxysilane, and even more desirably OCTMO. In addition, in these embodiments, it is further desirable that they contain at least about 16 wt. % of a High vMW PIB Resin (e.g., N100) up to about 20 or 25 wt. %, and that the weight ratio of the High vMW PIB Resin N100:Low vMW PIB Resin ranges from about 1:1 to about 1:3.

The PSAs of the present invention may be prepared in accordance with any standard mixing methodologies known in the art as regarding equipment, conditions (e.g., temperature, humidity) and desired deposition methods. The solid filler particles may be incorporated into the PSA via any known method, including without limitation, high speed dispersion, rotor/stator mixing, wet media milling, planetary milling and extrusion compounding.

The amount of ingredients used to prepare the embodiments of the present invention are based on the weight of the non-volatile components in the PSA. In this regard, and as is well understood by persons skilled in the art, the compositions as described herein may be diluted with a volatile component (e.g., toluene, heptane) to a solids content of between about 10 to about 20 wt. % and mixed until a homogenous composition is provided. This dilution, which lowers the viscosity of the composition, enables the composition to be coated onto a surface, and to provide a substantially uniform coated layer. After coating, the diluent is volatilized, leaving the filled PIB PSA as a film, ready for use. Alternatively, the PSA compositions of the present invention may be coated onto a substrate using a heat extrusion process, e.g., die extrusion or calendaring. As should be appreciated by those skilled in the art, PSA compositions applied via a heat extrusion process desirably do not include a volatile component (e.g., toluene, heptane) therein.

The inventive PSAs may be used for a variety of purposes, including without limitation, as moisture barrier tapes and adhesives for electronics applications, including in photovoltaic cells, electrochromatic windows, display assemblies (e.g., LCDs, LEDs and OLEDs, e-paper/e-ink etc.) and batteries (EV and other applications); chemically-resistant barrier tape for electronic applications, e.g., batteries (including LI-ion, solid state Li, zinc ion, and other electrolyte chemistries); skin adhesives (e.g., transdermal patches, surgical tapes and wound dressings); and medical devices, including microfluidic devices and PCR assemblies.

The PSAs of the present invention may be applied onto a variety of flexible and inflexible materials using the aforementioned and other conventional coating techniques to produce PSA-coated materials.

Flexible substrates are defined herein as any material which is conventionally utilized as a tape backing or may be of any other flexible material. Examples include, but are not limited to, plastic films such as polypropylene, polyethylene, ethylene vinyl acetate (EVA), polyvinyl chloride, (polyethylene polyester terephthalate), polycarbonate, polymethyl(meth)acrylate (PMMA), cellulose acetate, cellulose triacetate, and ethyl cellulose. Foam backings may be used. Examples of inflexible substrates include, but are not limited to, metal, metallized polymeric film, indium tin oxide coated glass and polyester, PMMA plate, polycarbonate plate, glass, or ceramic sheet material. The adhesive-coated sheet materials may take the form of any article conventionally known to be utilized with adhesive compositions such as labels, tapes, signs, covers, marking indices, display components, touch panels, and the like. Flexible backing materials having microreplicated surfaces are also contemplated.

The PSA also may be used as a component of a pressure-sensitive adhesive transfer tape in which at least one layer of the adhesive is disposed on a release liner for application to a secondary substrate at a later time. The PSA also may be provided as a single-coated or double-coated tape in which the adhesive is disposed on a permanent backing. Backings may be made from plastics (e.g., polypropylene, including biaxially oriented polypropylene, vinyl, polyethylene, ethylene vinyl acetate (EVA), polyester such as poly(ethylene terephthalate), nonwovens (e.g., papers, cloths, nonwoven scrims), metal foils, foams (e.g., polyacrylic, polyethylene, polyurethane, neoprene), and the like.

Foams are commercially available from various suppliers such as 3M, Voltek, Sekisui, and others. The foam may be formed as a coextruded sheet with the adhesive on one or both sides of the foam, or the adhesive may be laminated to it. When the adhesive is laminated to a foam, it may be desirable to treat the surface to improve the adhesion of the adhesive to the foam or to any of the other types of backings. Such treatments are typically selected based on the nature of the materials of the adhesive and of the foam or backing and include primers and surface modifications (e.g., corona treatment, surface abrasion). Additional tape constructions include those described in U.S. Pat. No. 5,602,221 (Bennett et al.), incorporated herein by reference. Those skilled in the art will also appreciate that other additives such as antioxidants, stabilizers, and colorants may be blended with the adhesive to provide additional beneficial properties

For a single-sided tape, the side of the backing surface opposite the side onto which the adhesive is disposed is typically coated with a suitable release material. Release materials are known and include materials such as, for example, silicone, polyethylene, polycarbamate, polyacrylics, and the like. For double-coated tapes, another layer of adhesive is disposed on the backing surface opposite the side onto which the inventive adhesive invention is disposed. The other layer of adhesive may be different from the adhesive of the invention, e.g., a conventional acrylic PSA, or it may be the same adhesive, with the same or a different composition. Double-coated tapes are typically carried on a release liner.

The above-described solvent-diluted PSA compositions may be applied onto a substrate using conventional coating techniques modified as appropriate to the particular substrate. For example, these compositions can be applied to a variety of solid substrates by methods such as roller coating, flow coating, dip coating, spin coating, spray coating, knife coating, and die coating. Alternatively, and when not solvent-diluted (e.g., toluene, heptane), the compositions of the present invention may be coated onto a substrate using a heat extrusion process, e.g., die extrusion or calendaring.

These various methods of coating allow the PSA compositions to be applied on a substrate at variable thicknesses thus allowing a wider range of uses. Coating thicknesses may vary depending on the application, but coating thicknesses of 0.1 to about 10, 20 or 30 mils (dry thickness), preferably about 0.1 to 10 mils, and more preferably about 0.1 to about 3 mils (dry thickness), are contemplated.

The PSAs contemplated by the present invention provide one or more advantageous properties, including, without limitation, desirable static shear strength, relatively low creep resistance, peel strength, liner release, and WVTR values. PSAs exhibiting a relatively low WVTR (and preferably in combination with other properties described herein) are highly desirable in certain applications.

### Preparation of the Adhesives for Testing

The filled PIB PSAs used in the testing described herein were prepared by introducing a specified amount of each ingredient (as described in the Tables) into a container, diluting these ingredients with toluene or heptane to a solids content of about 14 to about 20%, and mixing the diluted contents using disperser blades (3500 rpm) for 15 minutes at room temperature, thereby providing a liquid composition. The resulting liquid composition was coated onto a silicone release liner using a knife-over-roll down coater (e.g., ChemInstruments Laboratory Drawdown Coater) at a thickness which, after the diluent is volatilized, provided a dry film thickness of 1 mil (or 0.2 mils for coatings containing acetylene (carbon) black). Volatilization then proceeded by baking the liquid composition at 65° C. for 3 min, and then at 150° C. for 5 min. The resulting exposed PSA was then covered by a second release liner (e.g., a silicone coated PET release liner) to provide a PSA test specimen.

### Static Shear Strength

The static shear strength of a PSA was determined as follows.

A Pressure Sensitive Tape Council (PSTC) stainless steel (SS) panel onto which the adhesive is to be applied was cleaned with high purity urethane grade 2-butanone. A 0.5 inch×3 inch PSA test specimen (prepared as described above) was laminated onto an area of 0.5 in×0.5 in (12.7 mm×12.7 mm) of the PSTC stainless steel panel using a 4.5 lb, 80 durometer, hardness roller.

After a 30-minute dwell period, the SS panel onto which the test specimen was adhered was mounted vertically within a chamber that is pre-heated to 70° C. (and maintained at 70° C. for the duration of the testing), and static shear testing was initiated by hanging a 250 or 500 gram weight from the portion of the PSA test specimen that was not adhered to the SS panel, this combination referred to herein generally in the format of, e.g., “70° C., 500 g”). The time elapsed (minutes) until the weight falls was recorded as the static shear strength of the PSA.

Static shear strengths of various embodiments of the inventive PSAs, pursuant to this testing methodology, are described herein, but generally may be at least about 10, 20, 50, 100, 200, 500, 1,000, 2,000, 5,000 or 10,000 minutes. Testing was terminated upon reaching 10,000 minutes (almost 7 days) for practical reasons-10,000 minutes, therefore, may serve as an acceptable upper limit of static shear strength for purposes of describing the present invention. It should be understood, however, that various embodiments of the invention remained adhered at 10,000 minutes, and thus would be expected to provide static shear strengths exceeding 10,000 minutes.

### Peel Strength

The peel strength of a PSA was determined as follows.

The PSA to be tested was prepared in the same manner described previously.

A Pressure Sensitive Tape Council (PSTC) stainless steel (SS) panel onto which the adhesive is to be applied was cleaned with high purity urethane grade 2-butanone. A 1 in×10 in PSA test specimen (prepared as described above) was laminated onto the PSTC SS panel using a 4.5-lb, 80 durometer, hardness roller.

The testing was carried out in a controlled temperature (70° F.) and humidity (50% RH) environment. After a 15-minute dwell period, peel testing was initiated by pulling the tape from the PSTC SS plate at a rate of 12 inches/minute at an angle of 180 degrees. The load and displacement commonly increased to a maximum over the first 1 inch of the test, and then remained constant until the test was complete. The peel strength was determined by averaging the load (oz) observed between one- and five-inch displacement on the panel (based on a 1 inch sample width), thereby providing an oz/in value which is the PSA peel strength.

The peel strength of various embodiments of the inventive PSAs, pursuant to this testing methodology, are described herein, but generally may be at least about 10, 20, 30, 40, 50, 60, 70, 100, 150 or 200 oz/inch; 200 oz/inch may serve as the upper limit for peel strength for purposes of generally describing the present invention.

### Water Vapor Transmission Rate

The test for water vapor transmission rate (WVTR) of a PSA was performed using a Mocon Permatran-W 3/33 MA (Ametech-Mocon, Brooklyn Park, MN) as follows.

The PSA to be tested was prepared in the same manner described previously.

Prior to initiating testing in the Mocon Permatran device, a liner covering the PSA was removed, the PSA was placed onto a Celgard® sheet, and the PSA sample was placed on a Mocon 032-076 aluminum foil sheet to cover a hole in the sheet of 1 cm² and subjected to testing. The WVTR value for the PSA is that which was identifiable as the plateau value, which was commonly reached on or after about 12-36 hours.

The WVTR of various embodiments of the inventive PSAs, pursuant to this testing methodology, are described herein, but generally may have a WVTR that is no more than about 100, 80, 70, 50, 40, 30, 25, 20, 10 or 5 g-mil/m²/day, wherein 0.1 g-mil/m²/day may serve as a lower limit for WVTR for purposes of generally describing the present invention.

### Tight Liner Release

The test for tight liner release of a PSA was performed using a TMI Lab Master® Release & Adhesion Tester (New Castle, Delaware) as follows.

The PSA to be tested was prepared in the same manner described previously.

The testing was carried out in a controlled temperature (70° F.) and humidity (50% RH) environment. A 2 in×10 in PSA test specimen was subjected to testing in the device (300 inches/min at 180 degrees), wherein the release of the adhesive from the liner onto which the PSA composition was deposited (which may be referred to as the “tight” liner) was determined based on an average load (oz) between 1- and 5-inch displacement (noting the 2 inch sample width) thereby providing a gram/2 inch value which is the tight liner release.

The liners used in this test, as identified in the tables, were: AR-W2: Adhesives Research W-5002 (silicone); AR-W4: Adhesives Research W-5004 (silicone with tighter release relative to AR-W2; AR-R6: Mitsubishi 2PKRN 1.5 mil PET (silicone coated); and AR-R7: Mitsubishi 2PKRN 2.0 mil PET (silicone coated).

The tight liner release of various embodiments of the inventive PSAs, pursuant to this testing methodology, are described herein, but generally may have a tight liner release that is less than about 100, 90, 80, 70, 50, 40, 30 or 20 grams/2 inch, wherein about 5 grams/2 inch may serve as a lower limit for tight liner release for purposes of generally describing the present invention.

### Conductivity

The conductivity of the PSAs was assessed using a Keithley Micro-ohmmeter (Model 580) as follows.

The PSA to be tested was prepared in the same manner described previously, with the adhesive then being applied onto a removable AR-W4 liner at an initial thickness of 5 or 25.4 μm (the latter also referred to as being 1 mil in thickness), and then covered by a second removable Mitsubishi 2PKRN 2.0 mil PET liner, to provide a sample.

The testing protocol commenced by removing the second liner from the sample to expose one side of the PSA layer. A gold-plated stainless-steel electrode measuring 1 in×1 in was brought into contact with the freshly exposed PSA adhesive layer and pressed down firmly. While pressing down firmly, the PSA adhesive and AR-W4 liner were cut to the shape of the electrode, and separated from the larger sample. Thereafter, the AR-W4 liner was separated from the freshly cut 1 in² PSA adhesive/AR-W4 liner, and a second gold-plated stainless-steel electrode was pressed onto the freshly exposed PSA adhesive, wherein both electrodes were aligned edge-to-edge and faced each other to provide an assembled electrode.

The assembled electrode was then placed in a jig that allowed equal pressure to be applied onto the electrode, while allowing room for attaching conductive alligator clips. Thereafter, a current of 100 mA was applied to the electrodes, and a resistivity value (in mOhm) was obtained from the instrument at 11 lbs of force after waiting 30 seconds to allow the sample to equilibrate. Lower resistivity values correspond to higher sample conductivity, with higher conductivity values being desirable for PSA compositions containing acetylene black.

For purposes of the various embodiments of the inventive PSAs, a conductive PSA may have a resistivity value of about 0.25 to about 250 mOhms (as determined using the protocol described above).

Alternatively, the well-known four-point method may be utilized to assess the volume resistivity, surface resistivity, and conductivity of a PSA. The method, in general, requires a probe with four points of known diameters spaced apart relative to one another to be brought into contact with a subject PSA film, at which point a known current is applied to the two outer points, with the remaining two inner points being in communication with a voltmeter. The resistivity may be determined via the following known equation:

$$ρ = 2 π S ( V / I )$$

wherein ρ=resistivity (ohm·cm), S=needle spacing (cm), V=voltage between the inner probes (V), and I=Current through the outer probes. As is further known, if the thickness of a film to be tested is less than 5 times the point spacing, a correction factor should be applied. Also, if the thickness of the film is equal to or greater than 5 times the point spacing, the correction factor to be applied to the formula is less than 0.1%.

Using the four-point method, the volume resistivity of the PSA desirably may range from about 1 to about 1000 ohm·cm.

The following examples are provided to illustrate the present invention, and should be understood to not limit the scope of the invention.

### Example 1

Several PIB PSA compositions (which include OPPANOL® N100 as the high vMW PIB resin and OPPANOL® B12 as the low vMW PIB resin) with varying amounts of a non-surface treated fumed silica (NST Fumed Silica) were prepared and tested relative to an adhesive (A) which does not contain any fumed silica. The ingredients used to prepare the adhesives are set forth in Table 1, wherein the amount of each ingredient is set forth as a weight percent based on the total weight of the non-volatile ingredients in the composition.

After preparation, the adhesives tested as described herein and analyzed for static shear strength (70° C., 500 gram weight), adhesion to a stainless steel surface (peel strength), liner release, and moisture barrier (WVTR) properties in accordance with the testing protocols described herein. The values obtained are set forth in Table 1.

This example demonstrates that the PSA compositions with NST Fumed Silica provided enhanced static shear strength relative to the known adhesive, with the observed increase unexpectedly being non-liner relative to the amount of NST Fumed Silica used. Further, the peel strength (stainless steel) remained within an acceptable value for each NST Fumed Silica-containing composition tested, although the liner release (using silicone liners) was acceptable only for the 8 wt. % and 15 wt. % NST Fumed Silica-containing compositions. For applications in which a low WVTR (e.g., below about 5 g-mil/m²/day) is required, it was found that compositions including at least 8 wt. % NST Fumed Silica provided WVTR an order of magnitude higher (or more) relative to a PSA (A) that contains no NST Fumed Silica.

TABLE 1

| | | | | Solids | Static shear | | | |
|---|---|---|---|---|---|---|---|---|
| | High vMW | Low vMW | NST | Content and | (70° C., | Peel | Liner Release | WVTR |
| Formula | PIB Resin | PIB Resin | Fumed | Diluent for | 500 g) | (SS) | (silicone liners) | (g- mil/ |
| ID | (N100) | (B12) | Silica | Coating | (mins) | (oz/in) | (g/2 in) | m²/day) |
| A | 33.3 | 66.7 | 0 | 20% | 2-3 | 45 | 34.0 (AR- W4) | 2.2 |
| | | | | (heptane) | | | | |
| 1 | 26.0 | 52.0 | 22.0 | 12.7% | >10,000 | 49.9 | 226 (AR- W2) | 189 |
| | | | | (toluene) | | | 144 (AR- R6) | |
| 2 | 28.3 | 56.7 | 15.0 | 13.7% | 155.2 ± 44.5 | 52.5 | 36.1 (AR- W2) | 85.6 |
| | | | | (toluene) | | | 47.1 (AR- R7) | |
| 3 | 30.6 | 61.4 | 8.0 | 15.6% | 11.77 ± 0.7 | 45.6 | 17.8 (AR- W2) | 28.0 |
| | | | | (toluene) | | | 34.5 (AR- R7) | |

### Example 2

Several PIB PSA compositions (which include OPPANOL® N100 as the high vMW PIB resin and OPPANOL® B12 as the low vMW PIB resin) with varying amounts of a non-surface treated fumed alumina (NST Fumed Alumina) having a specific surface area (BET) ranging from about 85 to about 115 m²/gram were prepared and tested relative to an adhesive (A) which does not contain any fumed alumina. The ingredients used to prepare the adhesives are set forth in Table 2, wherein the amount of each ingredient is set forth as a weight percent based on the total weight of the non-volatile ingredients in the composition.

After preparation, the adhesives were analyzed for static shear strength (70° C., 500 gram weight), adhesion to a stainless steel surface (peel strength), liner release, and moisture barrier (WVTR) properties in accordance with the testing protocols described herein. The values obtained are set forth in Table 2.

This example demonstrates that the PSA compositions with NST Fumed Alumina provided enhanced static shear strength relative to the known adhesive, although at relatively higher loading relative to compositions which include NST Fumed Silicas. Unexpectedly higher static shear strength values were found when using a weight ratio of high vMW PIB resin (OPPANOL® N100):low vMW PIB resin (OPPANOL® B12) of about 1:3, with such unexpected beneficial increases found to begin at a weight ratio of about 1:2.5, with NST Fumed Alumina loading ranging from about 20 to about 30 wt. %. The NST Fumed Alumina was also unexpectedly found to provide improved tight liner release and WVTR relative to compositions that include similar amounts of NST Fumed Silicas.

TABLE 2

| | | | | Solids | Static shear | | Tight Liner | |
|---|---|---|---|---|---|---|---|---|
| | High vMW | Low vMW | NST | Content and | (70° C., | Peel | Release | WVTR |
| Formula | PIB Resin | PIB Resin | Fumed | Diluent for | 500 g) | (SS) | (silicone liners) | (g- mil/ |
| ID | (N100) | (B12) | Alumina | Coating | (mins) | (oz/in) | (g/2 in) | m²/day) |
| A | 33.3 | 66.7 | 0 | 20% | 2-3 | 45 | 34.0 (AR-W4) | 2.2 |
| | | | | (toluene) | | | | |
| 4 | 19.5 | 58.5 | 22.0 | 15% | 84.7 | 52.8 | | |
| | | | | (toluene) | | | | |
| 5 | 26.0 | 52.0 | 22.0 | 15% | 14.9-18.9 | 56.3 | | |
| | | | | (toluene) | | | | |
| 6 | 25.3 | 50.7 | 24.0 | 15.3% | 16.4-19.4 | | | |
| | | | | (toluene) | | | | |
| 7 | 22.3 | 55.7 | 22.0 | 15% | 32.3-58.5 | | | |
| | | | | (toluene) | | | | |
| 8 | 21.4 | 53.6 | 25.0 | 15% | 140.1 | 59.4 | 58.2 (AR-W2) | 50.8 |
| | | | | (toluene) | | | | |
| 9 | 16.5 | 53.5 | 30.0 | 12.3% | 178 | 49.4 | | |
| | | | | (toluene) | | | | |

### Example 3

Several PIB PSA compositions (which include OPPANOL® N100 as the high vMW PIB resin and OPPANOL® B12 as the low vMW PIB resin) with varying amounts of a surface-treated (ST) fumed alumina (i.e., a fumed alumina which has been surface-treated with a composition comprising an organosilane, the fumed alumina having a specific surface area (BET) ranging from about 75 to about 105 m²/gram) were prepared and tested relative to an adhesive (A) which does not contain any fumed alumina. The ingredients used to prepare the adhesives are set forth in Table 3, wherein the amount of each ingredient is set forth as a weight percent based on the non-volatile ingredients in the composition.

After preparation, the adhesives were analyzed for static shear strength (70° C., 500 gram), adhesion to a stainless steel surface (peel strength), tight liner release, and moisture barrier (WVTR) properties in accordance with the testing protocols described herein. The values obtained are set forth in Table 3.

This example demonstrates that the PSA compositions with ST Fumed Alumina provided enhanced static shear strength relative to the known adhesive, although at relatively higher loading levels, e.g., from about 22 to about 30 wt. %. Unexpectedly higher static shear strength values were found when using ST Fumed Alumina at about 30 wt. %, with this composition also exhibiting a relatively higher, yet still acceptable, peel strength, and further with an acceptable tight liner release. Loading at 40 wt. % was found to be undesirable, as the composition exhibited a loss of adhesion whereby static shear strength and peel strength could not be determined. A resin weight ratio of high vMW PIB resin:low vMW PIB resin of about 1:3 to about 1:3.5 was found to be most desirable for use with surface treated fumed aluminas at loading ranging from about 22 wt. % to about 30 wt. %, with loading at from about 22 to about 25 wt. % further, and desirably, providing WVTR values of less than about 30 g-mil/m²/day.

TABLE 3

| | | | | | | | Tight Liner | |
|---|---|---|---|---|---|---|---|---|
| | | | ST | Solids | Static shear | | Release | |
| | High vMW | Low vMW | Fumed | Content and | (70° C., | Peel | (silicone | WVTR |
| Formula | PIB Resin | PIB Resin | Alumina | Diluent for | 500 g) | (SS) | liners) | (g-mil/ |
| ID | (N100) | (B12) | (organosilane) | Coating | (mins) | (oz/in) | (g/2 in) | m²/day) |
| A | 33.3 | 66.7 | 0 | 20% | 2-3 | 45 | | 2.2 |
| | | | | (heptane) | | | | |
| 10 | 19.5 | 58.5 | 22 | 18.6% | 13.3 | 56.3 | | 23.5 |
| | | | | (toluene) | | | | |
| 11 | 17.7 | 57.4 | 25 | 17.8% | 20.3 | 64.9 | 14.9 | 24.9 |
| | | | | (toluene) | | | | |
| 12 | 16.5 | 53.5 | 30 | 18.9% | 147-179 | 62.9 | 15.8 | 124.6 |
| | | | | (toluene) | | | (AR-W2) | |
| 13 | 14.1 | 45.9 | 40 | 20% | 0 | ~0 | | |
| | | | | (toluene) | | | | |

### Example 4

Several PIB PSA compositions (which include OPPANOL® N100 as the high vMW PIB resin and OPPANOL® B12 as the low vMW PIB resin) with varying amounts of a surface-treated (ST) fumed silica (i.e., a fumed silica which has been surface-treated with a composition comprising an organosilane (A), an organosiloxane (B) or an organosilazane (C), the fumed silicas having a specific surface area (BET) ranging from about 125 to about 300 m²/gram) were prepared and tested relative to an adhesive (A) which does not contain any fumed silica. The ingredients used to prepare the adhesives are set forth in Table 4, wherein the amount of each ingredient is set forth as a weight percent based on the non-volatile ingredients in the composition. The ST Fumed Silica did not undergo any reaction.

After preparation, the adhesives were analyzed for static shear strength (70° C., 500 gram weight), adhesion to a stainless steel surface (peel strength), tight liner release, and moisture barrier (WVTR) properties in accordance with the testing protocols described herein. The values obtained are set forth in Table 4.

This example demonstrates that the PSA compositions with ST Fumed Silica provided enhanced static shear strength relative to the known adhesive, although unexpectedly at relatively higher loading levels within a defined range, e.g., from about 12 to about 25 wt. %, desirably from about 15 wt. % to about 25 wt. %, and more desirably from about 18 wt. % to about 25 wt. %, and even more desirably from about 22 to about 25 wt. %, with the shear strength increasing in a non-linear manner relative to the amount of the silica in the composition, until an unexpected decrease is exhibited at 27 wt. % loading.

Unexpectedly higher static shear strength values were found when using ST Fumed Silicas at about 30 wt. %, with this composition also exhibiting a relatively higher, yet still acceptable, peel strength, further, with a desirable tight liner release. Loading at 30 wt. % was found to result in a loss of adhesion, which in turn did not permit evaluation of the static shear strength and peel strength. A resin weight ratio of high vMW PIB resin:low vMW PIB resin of about 1:2 to about 1:7 was found to be most desirable for use with compositions including about 12 wt. % to about 25 wt. % ST Fumed Silicas, and more desirably a ratio of about 1:2 to about 1:3 with silica loading of from about 20 to about 25 wt. %, with a preferred ratio of about 1:3.

TABLE 4

| | | | | | | | | | Static | | | | |
|---|---|---|---|---|---|---|---|---|---|---|---|---|---|
| | High | Low | | | | | | | Shear | | | Tight Liner | |
| | vMW | vMW | ST | ST | ST | ST | ST | ST Fumed | Strength | Solids | Peel | Release | WVTR |
| | PIB | PIB | Fumed | Fumed | Fumed | Fumed | Fumed | Silica B | (70° C., | Content and | Strength | (silicone | (g- |
| Formula | Resin | Resin | Silica A | Silica A | Silica B | Silica B | Silica C | (CAB-O-SIL | 500 g) | Diluent for | (SS) | liners) | mil/ |
| ID | (N100) | (B12) | (R805) | (R711) | (R202) | (R208) | (R812) | TS-720D) | (mins) | Coating | (oz/in) | (g/2 in) | m²/day) |
| A | 33.3 | 66.7 | 0 | | | | | | 2-3 | 20% | 45 | 34.0 | 2.2 |
| | | | | | | | | | | (heptane) | | (AR- W4) | |
| 14 | 31.8 | 63.7 | 4.5 | | | | | | 4 | 16.6% | 49.9 | | |
| | | | | | | | | | | (toluene) | | | |
| 15 | 30.5 | 60.9 | 8.6 | | | | | | 8 | 16.6% | 52.5 | | |
| | | | | | | | | | | (toluene) | | | |
| 16 | 29.2 | 58.4 | 12.4 | | | | | | 10-13 | 15.8% | 45.6 | | |
| | | | | | | | | | | (toluene) | | | |
| 17 | 28.1 | 56.1 | 15.8 | | | | | | 23-26 | 15.4% | | | |
| | | | | | | | | | | (toluene) | | | |
| 18 | 26.0 | 52.0 | 22.0 | | | | | | 93-97 | 15.2% | | 17.9 | 3.2 |
| | | | | | | | | | | (toluene) | | (AR- W2) | |
| | | | | | | | | | | | | 28.4 | |
| | | | | | | | | | | | | (AR-R6) | |
| 19 | 24.2 | 48.4 | 27.4 | | | | | | 3 | 14.4% | | | |
| | | | | | | | | | | (toluene) | | | |
| 20 | 18.4 | 59.6 | 22 | | | | | | 282-304 | 19.1% | 55 | 16.7 | 11.1 |
| | | | | | | | | | | (toluene) | | (AR- W2) | |
| | | | | | | | | | | | | 26.6 | |
| | | | | | | | | | | | | (AR-W4 | |
| 21 | 27.0 | 52.2 | 27.0 | | | | | | 454 | 15.4% | | | |
| | | | | | | | | | | (toluene) | | | |
| 22 | 20 | 50 | 30 | | | | | | 1 | 15.9% | | | |
| | | | | | | | | | | (toluene) | | | |
| 23 | 18.8 | 56.2 | 25 | | | | | | >10,000 | 18.2% | 51.8 | 27.6 | 11.5 |
| | | | | | | | | | | (toluene) | | (AR- W4) | |
| 24 | 26.0 | 52.0 | | 22.0 | | | | | 18 | 13.9% | | | |
| | | | | | | | | | | (toluene) | | | |
| 25 | 19.5 | 58.5 | | 22.0 | | | | | 239-2398 | 17.6% | 28.6 | | |
| | | | | | | | | | | (toluene) | | | |
| 26 | 9.8 | 68.2 | | 22.0 | | | | | 117-130 | 20.0% | 24.2 | | |
| | | | | | | | | | | (toluene) | | | |
| 27 | 0 | 78.0 | | 22.0 | | | | | 1-5 | 24.0% | 42.9 | | |
| | | | | | | | | | | (toluene) | | | |
| 28 | 23.4 | 58.6 | | | 18 | | | | 46 | 13.9% | | | |
| | | | | | | | | | | (toluene) | | | |
| 29 | 23.4 | 58.6 | | | | 18 | | | 36 | 13.9% | | | |
| | | | | | | | | | | (toluene) | | | |
| 30 | 23.4 | 58.6 | | | | | 18 | | 68 | 13.9% | | | |
| | | | | | | | | | | (toluene) | | | |
| 31 | 23.4 | 58.6 | | | | | | 18 | 53 | 13.9% | | | |
| | | | | | | | | | | (toluene) | | | |

Adhesive compositions that include a weight ratio of high vMW PIB resin:low vMW PIB resin between about 1:2 to about 1:3, and a ST Fumed Silica loading of about 22 to about 25 wt. %, were found to provide desirable static shear, peel strength and silicone tight liner release properties, with relatively low WVTR. One exception is 24 which provided a relatively low static shear of 18 minutes, which is believed to be due to undesirable particulate aggregation.

### Example 5

A PIB PSA composition (which includes OPPANOL® N100 as the high vMW PIB resin and OPPANOL® B12 as the low vMW PIB resin) with 22 wt. % of a non-surface-treated (NST) hydrophilic fumed titanium dioxide was prepared and tested relative to an adhesive (A) which does not contain any fumed material. The ingredients used to prepare the adhesives are set forth in Table 5, wherein the amount of each ingredient is set forth as a weight percent based on the total weight of the non-volatile ingredients in the composition. The NST Fumed TiO₂ did not undergo any reaction.

After preparation, the adhesives tested as described herein and analyzed for static shear strength (70° C., 500 gram weight), adhesion to a stainless steel surface (peel strength), tight liner release, and moisture barrier (WVTR) properties using the testing protocols described herein. The values obtained are set forth in Table 5.

This example demonstrates that the PSA compositions with NST Fumed TiO₂ provided enhanced static shear strength relative to the known adhesive.

TABLE 5

| | | | | | Static shear | | |
|---|---|---|---|---|---|---|---|
| | High vMW | Low vMW | NST | Solids Content | (70° C., | Peel | WVTR |
| Formula | PIB Resin | PIB Resin | Fumed | and Diluent | 500 g) | (SS) | (g-mil/ |
| ID | (N100) | (B12) | TiO₂ | for Coating | (mins) | (oz/in) | m²/day) |
| A | 33.3 | 66.7 | 0 | 20% (heptane) | 2-3 | 45 | 2.2 |
| 32 | 26 | 52 | 22 | 16.9% (toluene) | 21 | | 51.6 |

### Example 6

A PIB PSA composition (which includes OPPANOL® N100 as the high vMW PIB resin and OPPANOL® B12 as the low vMW PIB resin) in varying amounts with surface-treated hydrophobic fumed silica (AEROSIL® R 805, surface treated with OCTMO) was prepared and tested relative to an adhesive (A) which does not contain any fumed material. The ingredients used to prepare the adhesives are set forth in Table 6, wherein the amount of each ingredient is set forth as a weight percent based on the total weight of the non-volatile ingredients in the composition. The ST Fumed silica did not undergo any reaction.

After preparation, the adhesives were tested as described herein and analyzed for static shear strength (70° C., 500 gram weight), adhesion to a stainless steel surface (peel strength), tight liner release, and moisture barrier (WVTR) properties using the testing protocols described herein. The values obtained are set forth in Table 6.

This example demonstrates that the inventive PSA compositions provide an unexpected increase in static shear strength and, to a lesser extent, peel strength, with the addition of tackifier to the formulation, as it was expected that shear strength would lessen as tackifier was added into the formulation. In addition, the data showed that preparing filled compositions with at least about 16 wt. % N100, at a N100:B12 weight ratio of about 1:1 to about 1:3 (with tackifier), and (unreacted) reactive surface-treated fumed silica at relatively high loading (e.g., amounts ranging from about 25 to about 30 wt. %), provided the formulation with static shear of at least one order of magnitude greater than comparative Formulation A (which contains no tackifier, no filler and a 1:2 weight ratio of N100:B12).

These data further suggest that, for these specific PSA compositions, wherein only the type of silica is varied, a PSA having excellent static shear strength, with acceptable peel, tight liner release and WVTR, may be prepared using AEROSIL® R805 or AEROSIL® R974 which are preferred relative to AEROSIL® 200 which exhibits an undesirable WVTR value.

TABLE 6

| | High | Low | | | | | | Static | | Tight Liner | |
|---|---|---|---|---|---|---|---|---|---|---|---|
| | vMW | vMW | | | | | Solids | shear | | Release | WVTR |
| | PIB | PIB | Tackifier | | | | Content and | (70° C., | Peel | (AR- W4 | (g- |
| Formula | Resin | Resin | (Indopol | | | | Diluent for | 500 g) | (SS) | Liner) | mil/ |
| ID | (N100) | (B12) | H1900) | R805 | 200 | R974 | Coating | (mins) | (oz/in) | (g/2 in) | m²/day) |
| A | 33.3 | 66.7 | | | | | 20% in | 3.0 | 45 | 34.0 | 2.2 |
| | | | | | | | heptane | | | | |
| 33 | 16.3 | 48.8 | 10.0 | 25.0 | | | 18.0% in | >10,000 | 53.9 | 25.8 | 11.3 |
| | | | | | | | toluene | | | | |
| 34 | 11.2 | 33.6 | 30.1 | 25.1 | | | 18.0% in | 68 | 58.6 | 31.9 | 10.3 |
| | | | | | | | toluene | | | | |
| 35 | 18.8 | 26.2 | 30.0 | 25.0 | | | 18.0% in | 366 | 54.3 | 25.0 | 9 |
| | | | | | | | toluene | | | | |
| 36 | 18.8 | 21.2 | 30.0 | 30.0 | | | 19.0% in | >10,000 | 49.4 | 56.9 | 11.6 |
| | | | | | | | toluene | | | | |
| 37 | 23.5 | 38.2 | 20.7 | | 17.6 | | 17.6% in | >10,000 | 59.2 | 51.6 | 129.7 |
| | | | | | | | toluene | | | | |
| 38 | 23.5 | 38.2 | 20.7 | | | 17.6 | 17.6% in | 70 | 51.4 | 26.9 | 8.8 |
| | | | | | | | toluene | | | | |
| 39 | 23.5 | 38.2 | 20.7 | 17.6 | | | 17.6% in | 16.4 | 57 | 28.9 | 10.4 |
| | | | | | | | toluene | | | | |

Legend:
R805 is AEROSIL ® R805 (ST)
200 is AEROSIL ® 200 (NST)
R974 is AEROSIL ® R974 (ST)

### Example 7

A PIB PSA composition (which includes OPPANOL® N100 as the high vMW PIB resin and OPPANOL® B12 as the low vMW PIB resin) in varying amounts with acetylene black was prepared and tested relative to an adhesive (A) which does not contain any acetylene black. The ingredients used to prepare the adhesives are set forth in Table 7, wherein the amount of each ingredient is set forth as a weight percent based on the total weight of the non-volatile ingredients in the composition.

After preparation, the adhesives were tested as described herein and analyzed for static shear strength (70° C., 500 gram weight), adhesion to a stainless steel surface (peel strength), tight liner release, and moisture barrier (WVTR) properties using the testing protocols described herein. The values obtained are set forth in Table 7.

This example demonstrates that static shear strength was increased when acetylene black was included at about 8 wt. %, with a more significant increase being found when this ingredient is included at about 15 wt. %, and up to about 22 wt. %. However, peel strength degraded at about 15 wt. % acetylene black, and at 22 wt. % was difficult to measure for some samples due to the poor adhesion to the backing substrate (the latter, in this case, being PET). The addition of a tackifier (at 30 wt. %) did not affect peel strength. This suggests a useful range of acetylene black of from about 10 to about 20 wt. %, and more desirably from about 12 to about 18 wt. %. for optimizing static shear strength while also maintaining acceptable peel strength, tight liner release and WVTR.

TABLE 7

| | High | Low | | | | Static | | Tight Liner | |
|---|---|---|---|---|---|---|---|---|---|
| | vMW | vMW | | | Solids | shear | | Release | WVTR |
| | PIB | PIB | Tackifier | | Content and | (70° C., | Peel | (AR-W4 | (g- |
| Formula | Resin | Resin | (Indopol | Acetylene | Diluent for | 500 g) | (SS) | Liner) | mil/ |
| ID | (N100) | (B12) | H1900) | Black | Coating | (mins) | (oz/in) | (g/2 in) | m²/day) |
| A | 33.3 | 66.7 | | | 20% in | 3.0 | 45 | 34.0 | 2.2 |
| | | | | | heptane | | | (AR- W4) | |
| 40 | 23.0 | 69.0 | | 8.0 | 18.0% in | 6.4 | 52.7 | 35.0 | 4.5 |
| | | | | | toluene | | | (AR- W4) | |
| 41 | 21.3 | 63.7 | | 15.0 | 18.0% in | 35.4 | 32.4 | 27.6 | |
| | | | | | toluene | | | (AR- W4) | |
| 42 | 19.5 | 58.5 | | 22.0 | 18.0% in | 68 | | 33.1 | 6.14 |
| | | | | | toluene | | | (AR- W4) | |
| 43 | 22.3 | 25.7 | 30 | 22 | 19.0% in | 68 | | 29.1 | |
| | | | | | toluene | | | (AR- W4) | |

### Example 8

A PIB PSA composition (which includes OPPANOL® N100 as the high vMW PIB resin and OPPANOL® B12 as the low vMW PIB resin) in varying amounts with acetylene black and (i) alumina, (ii) silica or (iii) alumina and silica, were prepared and tested relative to an adhesive (A) which does not contain any acetylene black, alumina or silica. The ingredients used to prepare the adhesives are set forth in Tables 8A, 8B and 8C, wherein the amount of each ingredient is set forth as a weight percent based on the total weight of the non-volatile ingredients in the composition.

After preparation, the adhesives were tested as described herein and analyzed for static shear strength (70° C., 500 gram weight), adhesion to a stainless steel surface (peel strength), tight liner release, moisture barrier (WVTR) and conductivity (assessed via determining Z-axis resistivity wherein low resistivity corresponds to high conductivity) properties using the testing protocols described herein. The values obtained are set forth in Tables 8A, 8B and 8C.

This example demonstrates, in many of the illustrative compositions, the combination of alumina and/or silica with acetylene black provided enhanced static shear strength without a significant loss of other desirable properties.

A comparison of properties obtained when combining acetylene black with different aluminas (AEROXIDE® Alu C versus AEROXIDE® Alu C 805) in a PSA demonstrated relatively higher static shear strength when using alumina (with Alu C providing higher static shear strength relative to Alu C 805 when included in the same amounts) relative to non-alumina-containing compositions, with acceptable peel strength and tight liner release values. See Table 8A. These values were optimized when acetylene black was included at about 10 to about 11 wt. % and Alu C was included at from about 11 to about 15 wt. %, with static shear strength also optimized when including at least one alumina at a range of about 10 to about 15 wt. %, particularly when Alu C 805 was used as the alumina ingredient. It was also found that an enhancement in static shear strength was observed at 7.5 wt. % of acetylene black and 7.5 wt. % alumina relative to acetylene black alone at 8 wt. %. The inclusion of alumina in varying amounts with acetylene black did not result in a significant change to the other measured properties, i.e., peel strength, tight liner release and WVTR. See Table 8A.

TABLE 8A

| | High | Low | | | Fumed | Fumed | | Static | | Tight Liner | |
|---|---|---|---|---|---|---|---|---|---|---|---|
| | vMW | vMW | | | Aluminum | Aluminum | Solids | shear | | Release | WVTR |
| | PIB | PIB | Tackifier | | Oxide | Oxide | Content and | (70° C., | Peel | (AR- W4 | (g- |
| Form. | Resin | Resin | (Indopol | Acetylene | (AEROXIDE | (AEROXIDE | Diluent for | 500 g) | (SS) | Liner) | mil/ |
| ID | (N100) | (B12) | H1900) | Black | Alu C) | Alu C 805) | Coating | (mins) | (oz/in) | (g/2 in) | m²/day) |
| A | 33.3 | 66.7 | | | | | 20% | 3.0 | 45 | 34.0 | 2.2 |
| | | | | | | | heptane | | | | |
| 44 | 21.3 | 63.7 | | 7.5 | 7.5 | | 18% | 14.6 | 43.6 | 33.1 | |
| | | | | | | | toluene | | | | |
| 45 | 19.5 | 58.5 | | 11.0 | 11.0 | | 18% | 110.4 | 44.2 | 29.0 | 16.6 |
| | | | | | | | toluene | | | | |
| 46 | 18.7 | 46.3 | 10.0 | 10.0 | 15.0 | | 18% | 90.6 | 28.7 | 30.8 | 40.3 |
| | | | | | | | toluene | | | | |
| 47 | 21.3 | 63.7 | | 7.5 | | 7.5 | 18% | 10.4 | 50.6 | 33.9 | 14.4 |
| | | | | | | | toluene | | | | |
| 48 | 19.5 | 58.5 | | 11.0 | | 11.0 | 18% | 35 | | 24.3 | 10.1 |
| | | | | | | | toluene | | | | |
| 49 | 18.7 | 46.3 | 10.0 | 10.0 | | 15.0 | 18% | 27.3 | | 23.4 | 9.3 |
| | | | | | | | toluene | | | | |

A comparison of properties obtained when combining acetylene black with different silicas (AEROSIL® R805 and AEROSIL® R974) in a PSA demonstrated relatively higher static shear strength when including silicas (with AEROSIL® R974 surprisingly providing higher static shear strength relative to R805 when included in the same amounts) relative to non-silica-containing compositions, with acceptable peel strength, tight liner release and WVTR values. See Table 8B. These values were optimized when acetylene black was included at about 10 to about 11 wt. % and the silicas included at from about 11 to about 15 wt. %, with AEROSIL® R974, again, demonstrating surprisingly high static shear strength when at least one silica, and particularly AEROSIL® R974, is included at from about 10 to about 15 wt. %. It was also found that an enhancement in static shear strength was observed at 7.5 wt. % of acetylene black and 7.5 wt. % silica relative to acetylene black alone at 8 wt. %. It was also noted that the inclusion of silica in varying amounts with acetylene black did not result in a significant change to the other measured properties, i.e., peel strength, tight liner release and WVTR. However, excellent values of static shear strength, peel strength, tight liner release and WVTR were observed when including AEROSIL® R974 in amounts ranging from about 11 to about 15 wt. %. See Table 8B.

TABLE 8B

| | High | Low | | | | | | Static | | Tight Liner | |
|---|---|---|---|---|---|---|---|---|---|---|---|
| | vMW | vMW | | | ST Fumed | ST Fumed | Solids | shear | | Release | WVTR |
| | PIB | PIB | Tackifier | | Silica | Silica | Content and | (70° C., | Peel | (AR-W4 | (g- |
| Form. | Resin | Resin | (Indopol | Acetylene | (AEROSIL | (AEROSIL | Diluent for | 500 g) | (SS) | Liner) | mil/ |
| ID | (N100) | (B12) | H1900) | Black | R805) | R974) | Coating | (mins) | (oz/in) | (g/2 in) | m²/day) |
| A | 33.3 | 66.7 | | | | | 20% | 3.0 | 45 | 34.0 | 2.2 |
| | | | | | | | heptane | | | | |
| 50 | 21.3 | 63.7 | | 7.5 | 7.5 | | 18% | 13.3 | 32.8 | 30.7 | |
| | | | | | | | toluene | | | | |
| 51 | 19.5 | 58.5 | | 11.0 | 11.0 | | 18% | 67.2 | 19.9 | 23.7 | 5.4 |
| | | | | | | | toluene | | | | |
| 52 | 18.7 | 46.3 | 10.0 | 15.0 | 15.0 | | 18.1% | 104.0 | 22.0 | 22.2 | 8.3 |
| | | | | | | | toluene | | | | |
| 53 | 21.4 | 26.8 | 26.8 | 12.5 | 10.0 | | 16.1% | 31.6 | 25.5 | 21.5 | 7.9 |
| | | | | | | | toluene | | | | |
| 54 | 21.3 | 63.7 | | 7.5 | | 7.5 | 18% | 18.2 | 37.1 | 27.6 | |
| | | | | | | | toluene | | | | |
| 55 | 19.5 | 58.5 | | 11.0 | | 11.0 | 18% | 127.3 | 22.5 | 14.1 | 8.1 |
| | | | | | | | toluene | | | | |
| 56 | 18.7 | 46.3 | 10.0 | 10.0 | | 15.0 | 18% | >10,000 | 21.8 | 17.6 | 7.8 |
| | | | | | | | toluene | | | | |

A comparison of properties obtained when combining acetylene black with a silica (AEROSIL® R805) and an alumina (AEROXIDE® Alu C) in a PSA demonstrated relatively higher static shear strength relative to non-silica-containing compositions, with acceptable peel strength, tight liner release and WVTR values. See Table 8C. However, it was surprisingly found that this specific combination of acetylene black, R805 and Alu C, while providing good static shear strength and peel strength, possessed an acceptable WVTR. See Table 8C.

TABLE 8C

| | High | Low | | | | Fumed | | Static | | Tight Liner | |
|---|---|---|---|---|---|---|---|---|---|---|---|
| | vMW | vMW | | | ST Fumed | Aluminum | Solids | shear | | Release | WVTR |
| | PIB | PIB | Tackifier | | Silica | Oxide | Content and | (70° C., | Peel | (AR-W4 | (g- |
| | Resin | Resin | (Indopol | Acetylene | (AEROSIL | (AEROXIDE | Diluent for | 500 g) | (SS) | Liner) | mil/ |
| ID | (N100) | (B12) | H1900) | Black | R805) | Alu C) | Coating | (mins) | (oz/in) | (g/2 in) | m²/day) |
| A | 33.3 | 66.7 | | | | | 20% | 3.0 | 45 | 34.0 | 2.2 |
| | | | | | | | heptane | | | | |
| 57 | 18.7 | 46.3 | 10.0 | 10.0 | 10.0 | 5.0 | 15.5% | 110.5 | 38.9 | 23.9 | 6.3 |
| | | | | | | | toluene | | | | |

A comparison of properties obtained when combining acetylene black with a ST silica (AEROSIL® R974) and a ST alumina (AEROXIDE® Alu C) in a PSA, relative to compositions without ST silica and alumina, and using only a relatively high vMW PIB resin, and desirably in certain amounts, unexpectedly demonstrated relatively higher static shear strength relative to non-silica-containing compositions, and further exhibited acceptable peel strength. See Table 8D. As demonstrated in Table 8D, the inclusion of ST silica of between about 8 and about 20 wt. %, and more desirably from about 12 to about 18 wt. %, were found to be optimal even in PSAs which include relatively high vMW PIB resin only (e.g., in amounts ranging from about 20 to about 30 wt. %, and desirably with a tackifier in an amount ranging from about 50 to about 60 wt. %. It was further found that including ST silica at about 25 wt. % resulted in a composition that was unable to form a film. See Table 8D.

TABLE 8D

| | High | Low | | | | | ST Fumed | | Static | |
|---|---|---|---|---|---|---|---|---|---|---|
| | vMW | vMW | | | | ST Fumed | Aluminum | Solids | shear | |
| | PIB | PIB | | Tackifier | | Silica | Oxide | Content and | (70° C., | Peel |
| | Resin | Resin | Tackifier | (Arkon | Acetylene | (AEROSIL | (AEROXIDE | Diluent for | 250 g) | (SS) |
| ID | (N100) | (B12) | (H1900) | P140) | Black | R974) | Alu C 805) | Coating | (mins) | (oz/in) |
| 58 | 13.1 | 52.5 | | 30 | 4.4 | | | 26.3% | 9 | 60 |
| | | | | | | | | (toluene) | | |
| 59 | 11.2 | 22.4 | 22.4 | 30 | 5 | 8 | 1 | 61.7% | 28.4 | 249 |
| | | | | | | | | (toluene) | | |
| 60 | 26 | | 52 | | 5 | 16 | 1 | 45.1% | >5000 | 57.3 |
| | | | | | | | | (toluene) | | |
| 61 | 7.8 | | 31.2 | 30 | 5 | 25 | 1 | | Film not | |
| | | | | | | | | | formed | |

### Example 9

An assessment of resistivity (as a proxy for conductivity, wherein a low resistivity value corresponds to a relativity, and desirable in this context, a high conductivity value) was conducted for a variety of compositions (with additional properties of many of these compositions be provided in Tables 7, 8A, 8B and 8C) which combined acetylene black with (i) aluminas (AEROXIDE® Alu C and AEROXIDE® Alu C 805) (ii) silicas (AEROSIL® R974 and AEROSIL® R805) and (iii) a mixture thereof. See Table 9.

Surprisingly, the resistivity of PSA compositions containing acetylene black and alumina was lower relative to compositions containing only acetylene black despite alumina being non-conductive. This general desirable effect on resistivity when including alumina with acetylene black was not observed to that same extent when using a combination of silicas and acetylene black (the resistivity of the latter silica combination being, generally, an order of magnitude higher than the former alumina combination, with the most promising resistivity values being obtained when the composition contained a combination of AEROXIDE® Alu C and acetylene black. See Table 9.

In PSA compositions containing a combination of silicas and acetylene black, it was unexpectedly found that compositions containing about 10 to about 11 wt. % acetylene black and about 10 to about 15 wt. % of an unreacted hydrophobic fumed silica (AEROSIL® R974, treated with DDS (dimethyldichlorosilane), or AEROSIL® R805) exhibited resistivity significantly less relative to a similar composition containing only 7.5 wt. % each of acetylene black and the same fumed silica. In the case of AEROSIL® R974 in an amount ranging from about 10 to about 15 wt. %, it was surprisingly found that the resistivity was an order of magnitude less relative to a composition containing only 7.5 wt. % each of acetylene black and the same fumed silica.

TABLE 9

| | High | Low | | | | | | | | |
|---|---|---|---|---|---|---|---|---|---|---|
| | vMW | vMW | | | | | | | Resistivity | |
| | PIB | PIB | Tackifier | | | | | | (mOhms) | |
| Formula | Resin | Resin | (Indopol | Acetylene | | | | Alu | 5 μm | 1 mil |
| ID | (N100) | (B12) | H1900) | Black | R805 | R974 | Alu C | C 805 | 11# | 11# |
| 62 | 23 | 69.0 | | 8 | | | | | 20.4 | 468.3 |
| 63 | 21.3 | 63.7 | | 15 | | | | | 4.6 | 16.8 |
| 64 | 19.5 | 58.5 | | 22 | | | | | 25.1 | 31.1 |
| 65 | 21.3 | 63.7 | | 7.5 | | | 7.5 | | | 207.8 |
| 56 | 19.5 | 58.5 | | 11 | | | 11 | | | 45.2 |
| 67 | 18.7 | 46.3 | 10 | 10 | | | 15 | | 2.9 | 40.9 |
| 68 | 21.3 | 63.7 | | 7.5 | 7.5 | | | | | 4222.3 |
| 69 | 19.5 | 58.5 | | 11 | 11 | | | | | 183.8 |
| 70 | 18.7 | 46.3 | 10 | 15 | 15 | | | | 124.6 | 368.93 |
| 71 | 21.4 | 26.8 | 26.8 | 12.5 | 10 | | | | 5.5 | 110.3 |
| 72 | 18.7 | 46.3 | 10 | 10 | | | 5 | | 7.2 | 91.2 |
| 73 | 21.3 | 63.7 | | 7.5 | | | | 7.5 | 8.7 | 1790.0 |
| 74 | 19.5 | 58.5 | | 11 | | | | 11.0 | 6.3 | 117.1 |
| 75 | 18.7 | 46.3 | 10 | 10 | | | | 15.0 | 8.7 | 194.9 |
| 76 | 21.3 | 63.7 | | 7.5 | | 7.5 | | | 2.0 | 4655 |
| 77 | 19.5 | 58.5 | | 11 | | 11.0 | | | 2.6 | 189.1 |
| 78 | 18.7 | 46.3 | 10 | 10 | | 15.0 | | | 2.5 | 347.5 |

Legend:
R805 is AEROSIL ® R805 (ST)
R974 is AEROSIL ® R974 (ST)
Alu C is AEROXIDE ® Alu C (NST)
Alu C 805 is AEROXIDE ® Alu C 805 (ST)

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “illustrative,” “such as”) provided herein, is intended merely to better illuminate the invention and does not pose a limitation on the scope of the invention unless otherwise claimed. No language in the specification should be construed as indicating any non-claimed element as essential to the practice of the invention.

References to weight percents herein should be understood to describe an amount of a component or ingredient based on the non-volatile components in the filled PIB PSA composition, unless contradicted by express language or context.

Although preferred embodiments of this invention are described herein, variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1.-84. (canceled)

85. A conductive pressure-sensitive adhesive comprising:
(a) about 10 wt. % to about 30 wt. % of a PIB resin having a vMW ranging from about 300,000 g/mol to about 3,000,000 g/mol:
(b) about 30 wt. % to about 60 wt. % of a PIB resin having a vMW ranging from about 35,000 g/mol to about 100,000 g/mol;
(c) about 5 wt. % to about 15 wt. % acetylene black; and
(d) about 5 wt. % to about 15 wt. % fumed alumina:
wherein the weight percents are based on total weight of the non-volatile ingredients in the pressure sensitive adhesive.

86. The adhesive according to claim 85, wherein the amount of fumed alumina in the adhesive ranges from about 10 wt. % to about 15 wt. %.

87. The adhesive according to claim 86, wherein the fumed alumina in the adhesive is a non-surface treated fumed alumina.

88. A conductive pressure-sensitive adhesive comprising:
(a) about 10 wt. % to about 30 wt. % of a PIB resin having a vMW ranging from about 300,000 g/mol to about 3,000,000 g/mol;
(b) about 30 wt. % to about 60 wt. % of a PIB resin having a vMW ranging from about 35,000 g/mol to about 100,000 g/mol; and
(c) about 5 wt. % to about 15 wt. % acetylene black; and
(d) about 5 wt. % to about 20 wt. % fumed silica:
wherein the weight percents are based on total weight of the non-volatile ingredients in the pressure sensitive adhesive, and
wherein the weight ratio of resin (a) to resin (b) ranges from about 1:2 to about 1:3.

89. The adhesive according to claim 88, wherein the fumed silica is a surface treated fumed silica.

90. A pressure-sensitive adhesive comprising:
(a) about 10 wt. % to about 30 wt. % of a PIB resin having a vMW ranging from about 300,000 g/mol to about 3,000,000 g/mol;
(b) about 30 wt. % to about 60 wt. % of a PIB resin having a vMW ranging from about 35,000 g/mol to about 100,000 g/mol:
(c) about 8 wt. % to about 25 wt. % of silica which has been surface-treated with a composition comprising an organosilane, an organosiloxane, an organosilazane or a mixture thereof:
wherein the weight percents are based on total weight of the non-volatile ingredients in the pressure sensitive adhesive.

91. The adhesive according to claim 90, wherein the silica in the adhesive is surface treated with an organosilane which is one or more of methacryloyloxypropyltrialkoxysilane, octyltrialkoxysilane, hexadecyltrialkoxysilane, dimethyldialkoxysilane, dimethyldichlorosilane or trimethylalkoxysilane.

92. The adhesive according to claim 90, wherein the silica in the adhesive is surface treated with dimethyldichlorosilane.

93. The adhesive according to claim 90, wherein the silica is a fumed silica, and wherein the adhesive comprises about 15 wt. % to about 25 wt. % of the fumed silica based on the non-volatile ingredients in the adhesive.

94. The adhesive according to claim 93, wherein adhesive comprises about 20 wt. % to about 25 wt. % fumed silica based on the non-volatile ingredients in the adhesive.

95. A pressure-sensitive adhesive comprising:
(a) about 10 wt. % to about 30 wt. % of a PIB resin having a vMW ranging from about 300,000 g/mol to about 3,000,000 g/mol;
(b) about 30 wt. % to about 60 wt. % of a PIB resin having a vMW ranging from about 35,000 g/mol to about 100,000 g/mol; and
(c) about 20 wt. % to about 30 wt. % of fumed alumina which has been surface-treated with a composition comprising an organosilane, an organosiloxane, an organosilazane or a mixture thereof;
wherein the weight ratio of resin (a) to resin (b) ranges from about 1:1 to about 1:4, and
wherein the weight percents and weight ratio are based on total weight of the non-volatile ingredients in the pressure sensitive adhesive.

96. The adhesive according to claim 95, wherein the fumed alumina in the adhesive is surface treated with one or more of methacrylsilane, octyltrimethoxysilane, hexadecylsilane or dimethyldichlorosilane.

97. The adhesive according to claim 95, wherein the fumed alumina in the adhesive is surface treated with hexamethyldisilazane.

98. A tape comprising:
(a) a substrate comprising an upper and lower surface;
(b) a pressure-sensitive adhesive of claim 85 on at least part of the upper portion of the substrate; and
(c) a release liner having a surface which contacts at least a portion of the pressure-sensitive adhesive.

99. A tape comprising:
(a) a substrate comprising an upper and lower surface:
(b) a pressure-sensitive adhesive of claim 88 on at least part of the upper portion of the substrate; and
(c) a release liner having a surface which contacts at least a portion of the pressure-sensitive adhesive.

100. A tape comprising:
(a) a substrate comprising an upper and lower surface;
(b) a pressure-sensitive adhesive of claim 90 on at least part of the upper portion of the substrate; and
(c) a release liner having a surface which contacts at least a portion of the pressure-sensitive adhesive.

101. A tape comprising:
(a) a substrate comprising an upper and lower surface;
(b) a pressure-sensitive adhesive of claim 95 on at least part of the upper portion of the substrate; and
(c) a release liner having a surface which contacts at least a portion of the pressure-sensitive adhesive.
